(19) United States
(12) Patent Application Publication
(10) Pub. No.: US 2024/0430894 A1
(43) Pub. Date: Dec. 26, 2024

(54) COMMUNICATION CONTROL METHOD

(71) Applicant: KYOCERA Corporation, Kyoto (JP)

(72) Inventors: Masato FUJISHIRO, Yokohama-shi (JP); Hiroyuki URABAYASHI, Yokohama-shi (JP)

(73) Assignee: KYOCERA Corporation, Kyoto (JP)

(21) Appl. No.: 18/822,950

(22) Filed: Sep. 3, 2024

Related U.S. Application Data
(63) Continuation of application No. PCT/JP2023/007490, filed on Mar. 1, 2023.

(30) Foreign Application Priority Data
Mar. 2, 2022 (JP) 2022-032194

(51) Int. Cl. H04W 72/20; H04W 36/08; H04W 72/04; H04W 74/0808

(52) U.S. Cl. CPC H04W 72/20; H04W 36/08; H04W 72/04; H04W 74/0808

(57) ABSTRACT

In an aspect, a communication control method is a communication control method in a wireless communication system. The communication control method includes a step of transmitting, by a base station, a first radio resource used for communication between a user equipment and a wireless tag to the user equipment. The communication control method includes a step of performing, by the user equipment, the communication with the wireless tag by using the first radio resource. The first radio resource is a radio resource different from a second radio resource used for the communication between the base station and the user equipment.

### RELATED APPLICATIONS

The present application is a continuation based on PCT Application No. PCT/JP2023/007490, filed on Mar. 1, 2023, which claims the benefit of Japanese Patent Application No. 2022-032194 filed on Mar. 2, 2022. The content of which is incorporated by reference herein in their entirety.

### TECHNICAL FIELD

The present disclosure relates to a communication control method in wireless communication systems.

### BACKGROUND

In The Third Generation Partnership Project (3GPP), which is a standardization project for mobile communication systems, Passive IoT has been discussed (e.g., see Non-Patent Documents 1 to 3).

The passive IoT is a technology that supports, for example, ultra-low power devices with ultra-low costs.

### CITATION LIST

### Non-Patent Literature

Non-Patent Document 1: 3GPP Contribution RP-212688
Non-Patent Document 2: 3GPP Contribution RP-213368
Non-Patent Document 3: 3GPP Contribution RP-213369

### SUMMARY

In a first aspect, a communication control method is a communication control method in a wireless communication system. The communication control method includes a step of transmitting, by a base station, a first radio resource used for communication between a user equipment and a wireless tag to the user equipment. The communication control method includes a step of performing, by the user equipment, the communication with the wireless tag by using the first radio resource. The first radio resource is a radio resource different from a second radio resource used for the communication between the base station and the user equipment.

In a second aspect, a communication control method is a communication control method in a wireless communication system. The communication control method includes a step of transmitting, by a base station, passive link support information to a user equipment, the passive link support information indicating whether the base station supports a passive link.

The communication control method includes a step of performing, by the user equipment, cell reselection with priority given to a cell supporting the passive link when the base station supports the passive link and a predetermined condition is met. The predetermined condition includes any one of the user equipment having a wireless tag subordinate to the user equipment, the user equipment being interested in communication with the wireless tag by using the passive link, and the user equipment being performing the communication with the wireless tag by using the passive link.

### BRIEF DESCRIPTION OF THE DRAWINGS

FIG. 1 is a diagram illustrating a configuration example of a wireless communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a wireless tag according to the first embodiment.

FIG. 5 is a diagram illustrating a configuration example of a protocol stack for a user plane according to the first embodiment.

FIG. 6 is a diagram illustrating a configuration example of a protocol stack for a control plane according to the first embodiment.

FIG. 7 is a diagram for explaining a problem in a passive IoT according to the first embodiment.

FIGS. 8A and 8B are diagrams for explaining a scenario a according to the first embodiment.

FIGS. 9A to 9C are diagrams for explaining a scenario b according to the first embodiment.

FIG. 10 is a diagram for explaining a scenario c according to the first embodiment.

FIG. 11 is a diagram illustrating an operation example according to the first embodiment.

FIG. 12 is a diagram illustrating an operation example according to a second embodiment.

FIG. 13 is a diagram illustrating an operation example according to a third embodiment.

FIG. 14 is a diagram illustrating an operation example according to a fourth embodiment.

### DESCRIPTION OF EMBODIMENTS

In an aspect, occurrence of interference is suppressed. In an aspect, a base station can control communication between a user equipment and a wireless tag.

In an embodiment, a wireless communication system is described with reference to the drawings. In the description of the drawings, the same or similar parts are denoted by the same or similar reference signs.

### First Embodiment

### Configuration Example of Wireless Communication System

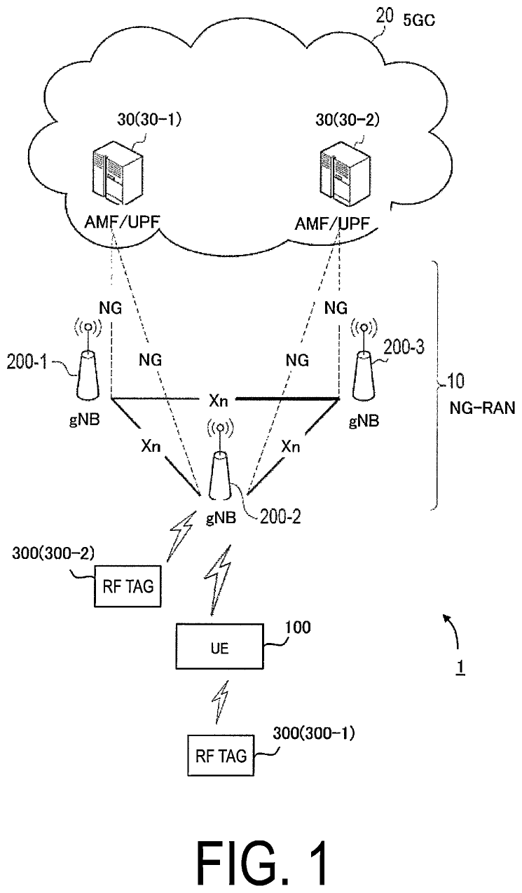

FIG. 1 is a diagram illustrating a configuration example of a wireless communication system according to a first embodiment. A wireless communication system 1 includes a mobile communication system that is the 5th Generation System (5GS) of the 3GPP standard. The description below takes the 5GS as an example of the mobile communication system, but a Long Term Evolution (LTE) system may be at least partially applied. A system of the sixth (6G) or subsequent generation system may be at least partially applied as the mobile communication system. Note that the wireless communication system 1 may be the mobile communication system.

The wireless communication system 1 includes a User Equipment (UE) 100, a 5G radio access network (Next Generation Radio Access Network (NG-RAN)) 10, and a 5G Core Network (5GC) 20, and a Radio Frequency (RF) tag 300. The 5GC 20 may be hereinafter simply referred to as a core network (CN) 20.

The UE 100 is a mobile wireless communication apparatus. The UE 100 may be any apparatus as long as it is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. Note that a “cell” is used as a term indicating a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) 30 and a User Plane Function (UPF). The AMF 30 performs various types of mobility controls and the like for the UE 100. The AMF 30 manages mobility of the UE 100 by communicating with the UE 100 by using Non-Access Stratum (NAS) signaling. The UPF controls data transfer. The AMF 30 and the UPF are connected to the gNB 200 via an NG interface, which is an interface between the base station and the core network.

An RF tag (or wireless tag, and may be referred to as a “wireless tag”) 300 is a wireless communication apparatus capable of wireless communication with the UE 100 or the gNB 200. The wireless tag 300 is also an information medium including a built-in memory to and from which data or the like is written or read using radio waves or electromagnetic fields. The wireless tag 300 is, for example, an Internet of Things (IoT) device that is extremely small, thin, lightweight, and low complexity.

### Configuration Example of UE

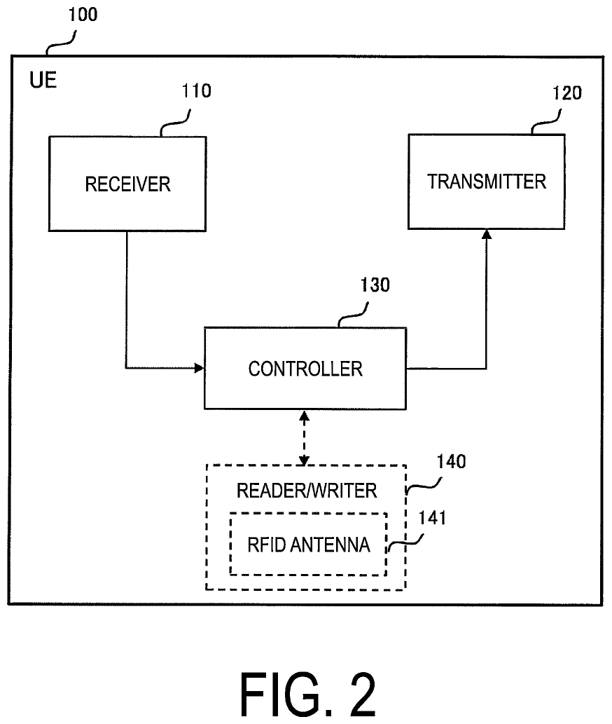

FIG. 2 is a diagram illustrating a configuration example of the UE 100 (user equipment) according to the first embodiment. The UE 100 includes a receiver 110, a transmitter 120, and a controller 130. The UE 100 may include a reader/writer 140. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. In the example described below, operations or processing in the UE 100 may be performed by the controller 130.

The reader/writer 140 includes a Radio Frequency identifier (RFID) antenna 141. The reader/writer 140 communicates with the wireless tag 300 via the RFID antenna 141 under control of the controller 130. The reader/writer 140 communicates with the wireless tag 300 using the RFID technology. The RFID technology is a technology for writing or reading data to and from the wireless tag 300 in a non-contact manner using radio waves or electromagnetic fields. The reader/writer 140 can also cause the wireless tag 300 to generate electric power using radio waves or electromagnetic fields transmitted from the RFID antenna 141. The UE 100 is capable of wireless communication with the wireless tag 300 via the reader/writer 140. Note that the reader/writer 140 may have only a reader function without a writer function.

Note that the reader/writer 140 can also perform wireless communication with the wireless tag 300 using a communication protocol in accordance with the 3GPP. In this case, instead of the RFID antenna 141, an antenna capable of transmitting and receiving a radio signal having a frequency used for the 3GPP may be included in the reader/writer 140. The reader/writer 140 can also perform wireless communication with the wireless tag 300 using backscattering (or backward scattering). In this case, an antenna capable of transmitting and receiving a frequency signal used in the backscattering may be included in the reader/writer 140. Note that backscattering is described in detail later.

### Configuration Example of gNB

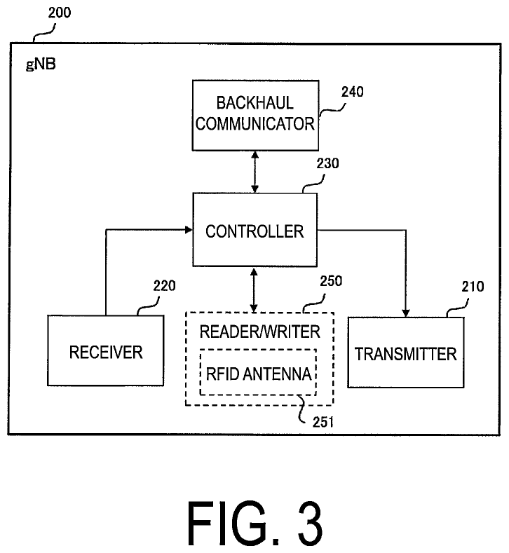

FIG. 3 is a diagram illustrating a configuration example of the gNB 200 (base station) according to the first embodiment. The gNB 200 includes a transmitter 210, a receiver 220, a controller 230, and a backhaul communicator 240. The gNB 200 may include a reader/writer 250. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing in the gNB 200 may be performed by the controller 230.

The backhaul communicator 240 is connected to a neighboring base station via an Xn interface, which is an inter-base station interface. The backhaul communicator 240 is connected to the AMF 30/UPF via the NG interface between the base station and the core network. Note that the gNB 200 may include a Central Unit (CU) and a Distributed Unit (DU) (i.e., functions are divided), and the two units may be connected via an F1 interface, which is a fronthaul interface.

The reader/writer 250 includes an RFID antenna 251. The reader/writer 250 communicates with the wireless tag 300 via the RFID antenna 251 under control of the controller 230. The reader/writer 250 writes and reads data to and from the wireless tag 300 in a non-contact manner using radio waves or electromagnetic fields transmitted from the RFID antenna 251. The reader/writer 250 can also cause the wireless tag 300 to generate electric power using radio waves or electromagnetic fields transmitted from the RFID antenna 251. The gNB 200 is capable of wireless communication with the wireless tag 300 via the reader/writer 250. Note that the reader/writer 250 may have only the reader function without the writer function.

Note that the reader/writer 250 can also perform wireless communication with the wireless tag 300 using a communication protocol in accordance with the 3GPP. In this case, instead of the RFID antenna 251, an antenna capable of transmitting and receiving a radio signal having a frequency used for the 3GPP may be included in the reader/writer 250. The reader/writer 250 can also perform wireless communication with the wireless tag 300 using backscattering. In this case, an antenna capable of transmitting and receiving a frequency signal used in the backscattering may be included in the reader/writer 250.

### Configuration Example of Wireless Tag

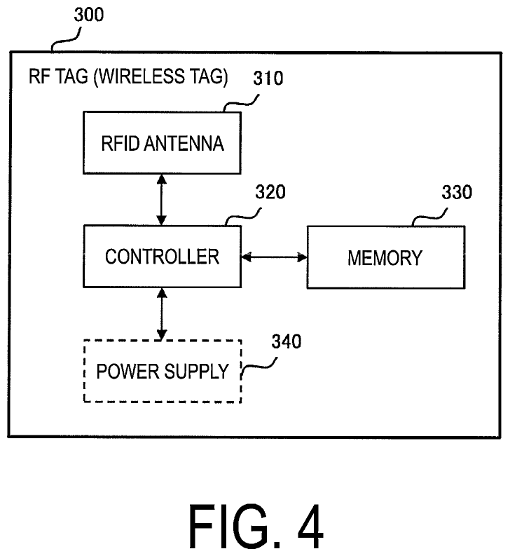

FIG. 4 is a diagram illustrating a configuration example of the wireless tag 300 according to the first embodiment. The wireless tag 300 includes an RFID antenna 310, a controller 320, and a memory 330. The wireless tag 300 may include a power supply 340.

The RFID antenna 310 performs wireless communication with the UE 100 or the gNB 200 using the RFID technology. As described above, the RFID technology includes a radio wave type and an electromagnetic induction type.

The radio wave type is a type of transmitting energy and signals using radio waves. In this case, the RFID antenna 310 receives radio waves transmitted from the UE 100 or the gNB 200, and a rectifier circuit provided in the RFID antenna 310 outputs part of the radio waves as DC power supply to the controller 320. This causes the controller 320 to operate. The RFID antenna 310 converts the received radio wave into a reception signal by a demodulation circuit or the like provided in the RFID antenna 310, and outputs the reception signal to the controller 320. Note that the RFID antenna 310 converts a transmission signal received from the controller 320 into a radio signal by a modulation circuit or the like provided in the RFID antenna 310, and transmits the radio signal to the UE 100 or the gNB 200. In this case, the RFID antenna 310 may transmit the radio signal by using a reflected wave of a received radio wave received from the UE 100 or the gNB 200.

The electromagnetic induction type is a type of causing an antenna coil to generate an electromagnetic field by electromagnetic induction and transmitting energy and signals. For the electromagnetic induction type, the RFID antenna 310 is a loop coil antenna. Both the RFID antenna 141 in the UE 100 and the RFID antenna 251 in the gNB 200 are loop coil antennas. The electromagnetic induction type is similar to and/or the same as the radio wave type in that power supply to the controller 320 is obtained by a rectifier circuit, a reception signal is obtained by a demodulation circuit, and a reflected wave may be used.

The controller 320 receives a reception signal from the RFID antenna 310. For example, the controller 320 writes data included in the reception signal to the memory 330 in accordance with indication information included in the reception signal. The controller 320 reads data from the memory 330 in accordance with the indication information included in the reception signal, for example. The controller 320 outputs a transmission signal including the read data to the RFID antenna 310. In the example described below, operations or processing in the wireless tag 300 may be performed by the controller 320.

The memory 330 stores an identifier of the wireless tag 300 (or identification information of the wireless tag 300. Hereinafter, the “identifier” and the “identification information” are not distinguished form each other in some cases), data, and the like. The memory 330 of the wireless tag 300 may adopt the Electronic Product Code (EPC) Class 1 Generation 2 (GEN2) standard conforming to ISO/IEC 18000-63. The memory 330 of the EPC GEN2 standard has four memory areas of a USER memory, a Tag ID (TID) memory, an EPC memory, and a RESERVED memory. The USER memory is an area that can be freely written to and read from by a user using the wireless tag 300. The TID memory is an area that a manufacturer, model information, and the like of the wireless tag 300 are written. The TID memory is a readable and non-writable area. The EPC memory is an area that the identifier of the wireless tag 300 is written. The RESERVED memory is an area that password information of the wireless tag 300 is written. The password information includes password information used to lock writing to the wireless tag 300 and password information used to Kill the wireless tag 300.

The power supply 340 is, for example, a power supply using energy harvesting. An environment for harvesting includes heat, vibration, motion, light, wind, radio wave, or biotechnology. The energy harvesting is a power generation method in which an electromotive force is obtained from the surrounding environment as described above. The energy harvesting is different from a power generation method using a battery such as a secondary battery. However, the wireless tag 300 may be equipped with a battery to generate power by itself like an active tag. For this reason, the power supply 340 may be a battery power supply.

Note that the wireless tag 300 may have only the reader function of reading data or the like from the memory 330 without the writer function of writing data or the like to the memory 330.

The wireless tag 300 can also perform wireless communication with the UE 100 or the gNB 200 using a communication protocol in accordance with the 3GPP. In this case, instead of the RFID antenna 310, an antenna capable of transmitting and receiving a radio signal having a frequency used for the 3GPP may be included in the wireless tag 300.

Hereinafter, a communication method of the wireless tag 300 is described as using the RFID technology, but is not limited thereto. For example, the communication method of the wireless tag 300 may use a 3GPP-compliant communication protocol. The wireless tag 300 may perform communication by using backscattering.

### Protocol Stack

A configuration example of the protocol stack is described. Here, a configuration example of the protocol stack in the UE 100, the gNB 200, and the AMF 30 other than the wireless tag 300 is described.

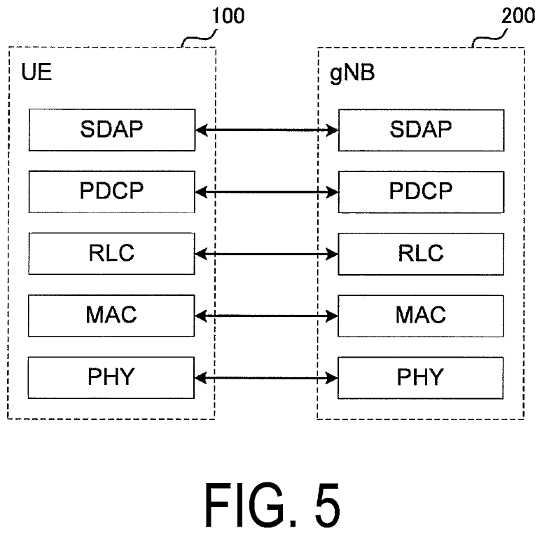

FIG. 5 is a diagram illustrating a configuration example of a protocol stack of a radio interface of a user plane handling data.

The radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions

of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

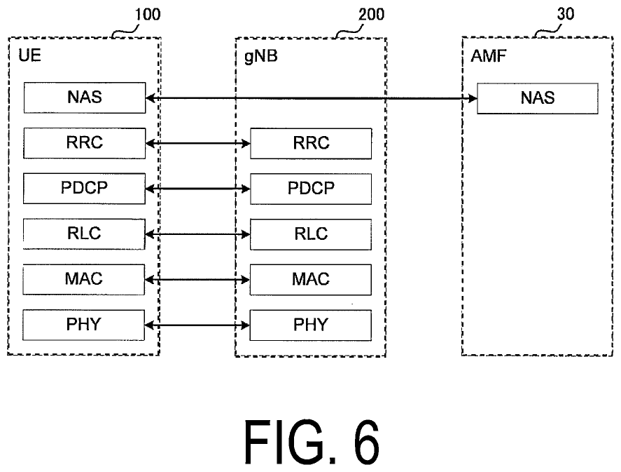

FIG. 6 is a diagram illustrating a configuration example of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 5.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is positioned upper than the RRC layer, performs session management, mobility management, and the like. NAS signaling is transmitted between the NAS of the UE 100 and the NAS of the AMF 30. Note that the UE 100 includes an application layer other than the protocol of the radio interface. A layer lower than the NAS is referred to as Access Stratum (AS).

### Passive IoT

The passive IoT is a technology that supports, for example, ultra-low power devices with ultra-low costs. Hereinafter, a device supporting the passive IoT may be referred to as a “passive IoT device”. The wireless tag 300 is an example of the passive IoT device.

The passive IoT device supports an ultra-low power device. Due to the low power consumption of the passive IoT, the passive IoT device may not need to use a battery or may use the energy harvesting.

Even the passive IoT devices may be equipped with a power supply. However, even such a case can be realized by a small-capacity battery and/or the energy harvesting on the premise of low power consumption, and thus low cost can be realized as compared with a device using a large-capacity battery.

On the other hand, since the passive IoT device performs communication using low power as compared with the UE 100 of the 5G system, a coverage range is narrow. A communication time is limited and an amount of data that can be transmitted and received at a time is small. In the passive IoT, interference may occur when multiple passive IoT devices communicate at the same time. Therefore, in the passive IoT, communication may be unstable and irregular.

The passive IoT may target the RFID, for example. Types of the RFID include a passive tag, an active tag, and a semi-passive tag (or a semi-active tag). The passive tag is a wireless tag that uses radio waves from a reader as a power supply. The passive tag is assumed to be mainly used for the passive IoT. The active tag is a wireless tag that uses a battery built in the wireless tag as a power supply. The semi-passive tag is a wireless tag that normally operates as a passive tag and operates as an active tag in response to a request from a reader. The passive IoT may target, for example, the semi-passive tag or the active tag.

Targets for the passive IoT include the backscattering, for example. The backscattering refers to reflection of a radio wave, a particle, or a signal back to a direction from which the radio wave, the particle, or the signal came. As described above, the backscattering in the passive IoT is used in the communication method using the reflected wave. The wireless tag 300 can modulate a reflected wave to transmit data by using the reflected wave.

Further, the targets for the passive IoT include the energy harvesting, for example. As described above, the energy harvesting is the power generation in which power is obtained from the environment. For example, in the energy harvesting, energy such as vibration or heat is converted into electrical energy to generate power. The energy harvesting may include solar panels or windmills. The low power consumption of the passive IoT allows the energy harvesting to be used as a power supply. Unlike a battery, the energy harvesting does not need to be charged or replaced, and thus can operate for a long time without maintenance.

### Problem of Passive IoT

When the passive IoT can be accommodated in a mobile communication system conforming to the 3GPP, for example, the passive IoT device can be managed also in the NG-RAN 10 or the CN 20.

However, when the passive IoT is accommodated in the mobile communication system, some problems may be considered.

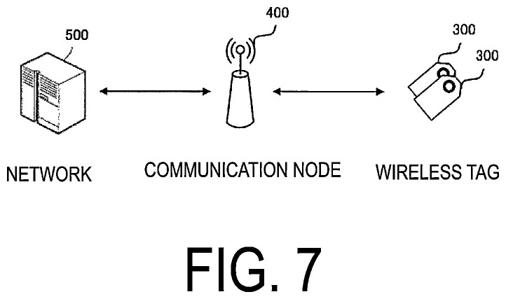

FIG. 7 is a diagram for explaining a problem in the passive IoT according to the first embodiment. In FIG. 7, a network 500 and a communication node 400 are included in the mobile communication system conforming to the 3GPP. The communication node 400 is a node that has the reader/writer function and communicates with the wireless tag 300. The communication node 400 may be the UE 100 or the gNB 200. On the other hand, the network 500 includes apparatuses communicating with the communication node 400. The network 500 is the CN 20 or the gNB 200.

When viewed from the network 500 (CN 20 or gNB 200), a problem is whether the wireless tag 300 is managed as a wireless tag or the UE 100. In the network 500, when the wireless tag 300 can be managed as the UE 100, the wireless tag 300 can be also handled in the same manner as the UE 100.

A problem is also whether the reader function (and/or writer function) is performed by the UE 100 or the gNB 200. Not only the UE 100 but also the gNB 200 can directly communicate with the wireless tag 300.

A further problem is whether the link between the communication node 400 and the wireless tag 300 uses existing specifications such as the RFID or uses the 3GPP-compliant communication protocol. Alternatively, a problem is whether a 3GPP-compliant communication band is used or a communication band for RFID (13.56 MHz band, 900 MHz band, or the like) is used.

As described above, there are several problems in order to accommodate the passive IoT in the mobile communication system. It will be understood that all or part of the above-described problems can be solved in the embodiments described below.

### Passive IoT Scenario

As scenarios in which passive IoT is used, the following three scenarios (scenario a, scenario b, and scenario c) are assumed. Note that although the communication node 400 is present in the three scenarios, the communication node 400 may be, for example, either the UE 100 including the reader/writer 140 or the gNB 200 including the reader/writer 250.

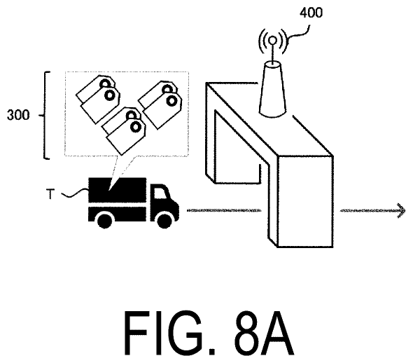

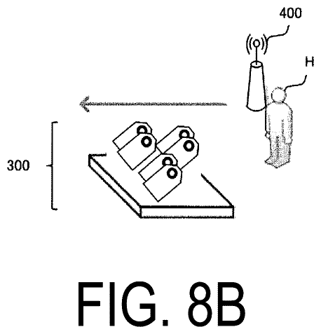

FIGS. 8A and 8B are diagrams for explaining the scenario a according to the first embodiment. The scenario a is, for example, a scenario in which the passive IoT is locally used.

As illustrated in FIG. 8A, when the wireless tag 300 loaded on a moving object such as a truck T (or a pallet) passes through a gate, the communication node 400 detects the wireless tag 300. The wireless tag 300 may be attached to each product. The wireless tag 300 may be attached to each pallet accommodating products. For example, the communication node 400 provided to a main gate of a factory detects the wireless tag 300, which enables management of products shipped from the factory or management of parts entering the factory.

An example of FIG. 8B is an example in which a moving object (e.g., a human H or a moving vehicle) moves the communication node 400 to detect the wireless tag 300 loaded on a fixed object (e.g., a pallet). The wireless tag 300 may be attached to each product. The wireless tag 300 may be attached to each pallet. The detection by the wireless tag 300 enables, for example, products loaded on a pallet to be managed.

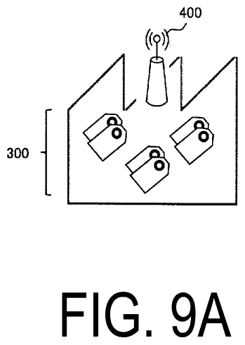

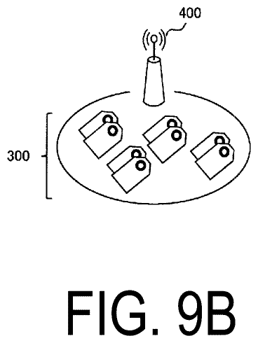

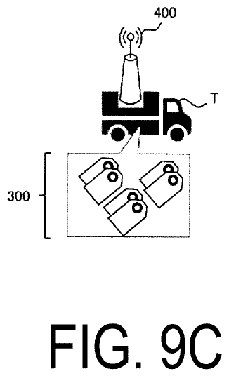

FIGS. 9A to 9C are diagrams for explaining the scenario b according to the first embodiment. The scenario b is a scenario for managing the wireless tag 300 existing in a certain location. The location may be a factory (or warehouse) (FIG. 9A), a particular area (FIG. 9B), or a load of the truck T (FIG. 9C). The communication node 400 manages the wireless tag 300 existing in the location, which enables inventory management of products or parts in the factory, management of products or part loaded on the truck T, and the like.

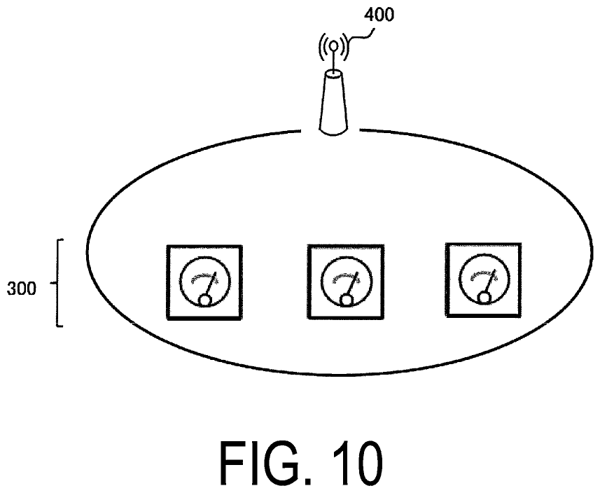

FIG. 10 is a diagram for explaining the scenario c according to the first embodiment. The scenario c is a scenario in which the wireless tag 300 disposed or existing in a certain location continuously or periodically reads a measurement value. For example, a thermometer and the wireless tag 300 connected to the thermometer are disposed in a site or a pasture. The wireless tag 300 can acquire a measurement value (temperature information) from the thermometer. Then, the communication node 400 continuously or periodically reads the measurement value from the wireless tag 300, which enables temperature management in the site, the pasture, or the like.

### Communication Control Method According to First Embodiment

A communication control method according to the first embodiment is described.

In the first embodiment, a case is described in which the communication node 400 is the UE 100 and the network 500 is the gNB 200.

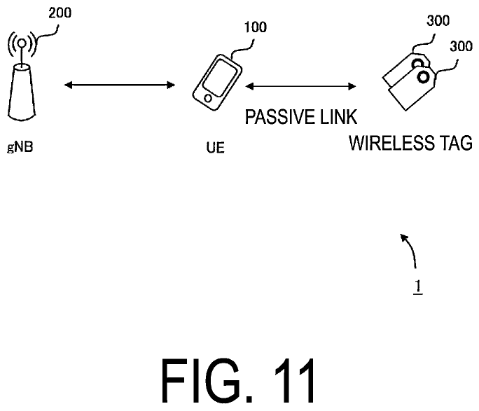

FIG. 11 is a diagram illustrating a configuration example of the wireless communication system 1 according to the first embodiment. As illustrated in FIG. 11, a passive link is established between the UE 100 and the wireless tag 300. The passive link is, for example, a communication link between the UE 100 and the wireless tag 300.

Here, the passive link according to the first embodiment is configured as follows.

First, the passive link uses a frequency band (e.g., a licensed band) used in a mobile communication system conforming to the 3GPP.

Second, the passive link may use a communication protocol in accordance with the 3GPP. The passive link may use a non-3GPP communication protocol such as an RFID.

Third, in the passive link, the wireless tag 300 may be a passive tag, a semi-passive tag, or an active tag. In the passive link, not only passive communication with a passive tag but also active communication with an active tag may be performed.

Under such premises, the wireless communication system 1 including the wireless tag 300 has following problems.

That is, the passive link uses a frequency band used in a mobile communication system conforming to the 3GPP. Therefore, the communication in the passive link may interfere with the communication between the UE 100 and the wireless tag 300. When such interference occurs, the UE 100 may fail to appropriately communicate with the wireless tag 300.

The gNB 200 also desires to be able to control the communication in the passive link in the gNB 200. The gNB 200, by taking the initiative in the communication in the passive link, can perform control of the communication for the UE 100 and various controls.

Therefore, in the first embodiment, the occurrence of the interference is suppressed. In the first embodiment, the gNB 200 can control communication in the passive link.

Therefore, in the first embodiment, the gNB 200 notifies the UE 100 of a passive link radio resource. To be more specific, the base station (e.g., the gNB 200) transmits a first radio resource used for communication between the user equipment (e.g., the UE 100) and the wireless tag (e.g., the wireless tag 300) to the user equipment. Second, the user equipment performs communication with the wireless tag by using the first radio resource. The first radio resource is a radio resource different from a second radio resource used for the communication between the base station and the user equipment.

As described above, since the passive link radio resource is different from the radio resource used for the communication between the base station and the user equipment, the communication in the passive link interfering with the communication between the base station and the user equipment can be suppressed. The passive link radio resource is allocated and transmitted to the UE 100 by the gNB 200. Therefore, the gNB 200 can take the initiative to control the communication in the passive link through transmitting the passive link radio resource.

### Operation Example According to First Embodiment

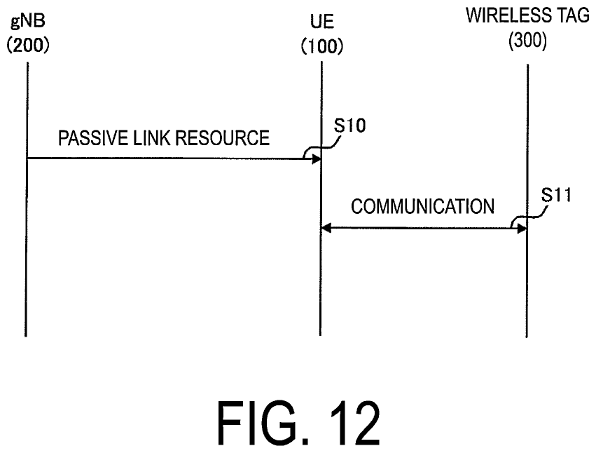

FIG. 12 is a diagram illustrating an operation example according to the first embodiment.

As illustrated in FIG. 12, in step S10, the gNB 200 transmits information regarding the passive link radio resource to the UE 100. A method for notification includes following two types.

First, the gNB 200 may transmit (broadcast) information regarding the radio resource by way of a System Information Block (SIB). The UE 100 not communicating with the wireless tag 300 may also receive the information regarding the radio resource. The passive link radio resource may be shared by multiple UEs 100. For example, consider a case in which there are the UE 100 communicating with the wireless tag 300 and another UE communicating with another wireless tag. In such a case, when a distance between the UE 100 and the other UE is equal to or more than a threshold, the passive link radio resource (e.g., the first radio resource) and another passive link radio resource (e.g., a third radio resource) between the other UE and another wireless tag may be the same as each other (that is, may be shared). In such a case, the gNB 200 may broadcast the system information block including the information regarding the radio resource.

Second, the gNB 200 may transmit the information regarding the radio resource using an RRC reconfiguration (RRCReconfiguration) message. For example, in the above-described case, when the distance between the UE 100 and the other UE is less than the threshold, the passive link radio resource (e.g., the first radio resource) and the other passive link radio resource (e.g., the third radio resource) may be different radio resources. In this case, the gNB 200 may transmit a first RRC reconfiguration message including the information regarding the passive link radio resource to the UE 100, and transmit a second RRC reconfiguration message including information regarding the other passive link radio resource to the UE 100. The gNB 200 may transmit the control information (Downlink Control Information (DCI)) or a MAC Control Element (MAC CE) including the information regarding the radio resource.

Specific examples of the information regarding the radio resource include the following.

First, the information regarding the radio resource includes time direction information of the radio resource. The time direction information may be represented by a Hyper Frame Number (HFN), a radio frame, a subframe, a slot, or the like. The time direction information may be represented by a start point and a period. The time direction information may include an end point in addition to the start point and the period. This information may include a pattern. The pattern may include a bitmap, where each bit corresponds to each time unit (e.g., subframe), and “0” may indicate disabled and “1” may indicate enabled. Note that “0” may indicate enabled, and “1” may indicate disabled.

Second, the information regarding the radio resource includes frequency direction information of the radio resource. The frequency direction information may be represented by a carrier frequency (or a center frequency), a Bandwidth Part (BWP), a Physical Resource Block (PRB), a resource element (RE), or the like.

Third, the information regarding the radio resource may include a passive link radio resource in a neighboring cell. The passive link radio resource in the neighboring cell may be associated with an identifier of the neighboring cell. The information regarding the radio resource may include information of a neighboring cell supporting the passive link. The information of the neighboring cell supporting the passive link may also be associated with an identifier of the neighboring cell.

Fourth, the information regarding the radio resource may include information specifying whether carrier sensing (Listen-Before-Talk (LBT)) is required for the communication between the UE 100 and the wireless tag 300. As described above, when the radio resource is shared by the multiple UEs 100, the carrier sensing may be performed in order to avoid the communication between the UE 100 and the wireless tag 300 from interfering with the communication between the other UE and the other wireless tag. The UE 100 may or may not perform the carrier sensing in accordance with the information specifying whether the carrier sensing is required.

In step S11, the UE 100 having the wireless tag 300 subordinated to the UE 100 performs communication with the wireless tag 300 using the passive link radio resource. The UE 100 performs transmission and reception to and from the wireless tag 300 in the radio resource. When the carrier sensing is specified, the UE 100 performs communication with the wireless tag 300 at the timing when succeeding in the LBT.

Note that the passive radio resource may exist in DL radio resources among the radio resources used for communications between the gNB 200 and the UE 100. However, the passive link radio resource, even when existing in the DL radio resources, is not shared with (used separately from) any of the DL radio resources. The passive radio resource may exist in UL radio resources among the radio resources used for communication between the gNB 200 and the UE 100. However, in this case also, the passive link radio resource, even when existing in the UL radio resources, is not shared with (used separately from) any of the UL radio resources.

The passive radio resource may exist in sidelink radio resources among the radio resources used for communications between the UEs 100. However, in this case also, the passive link radio resource, even when existing in the sidelink radio resources, is not shared with (used separately from) any of the sidelink radio resources.

The UE not having the wireless tag 300 subordinate thereto may stop monitoring the DL (that is, a Physical Downlink Control Channel (PDCCH)) in the passive link radio resource. This is in order to suppress interferences. The UE not having the wireless tag 300 subordinate thereto may stop transmitting the UL (that is, a Physical Uplink Control Channel (PUCCH)) in the passive link radio resource. The passive link radio resource may exist in sidelink radio resources among the radio resources used for communications between the UEs 100. However, in this case also, the passive link radio resource, even when existing in the sidelink radio resources, is not shared with (used separately from) any of the sidelink radio resources. In this case also, this is in order to suppress interferences. The UE not having the wireless tag 300 subordinate thereto may stop transmitting or receiving (monitoring) the sidelink (that is, a Physical Sidelink Control Channel (PSCCH) or a Physical Sidelink Shared Channel (PSSCH)) in the passive link radio resource. In this case also, this is in order to suppress interferences.

### Variation of First Embodiment

The passive link has been described as using a frequency band used in a mobile communication system conforming to the 3GPP, but is not limited thereto. The passive link may use other frequency bands. The other frequency bands may include, for example, an unlicensed band (a frequency band not requiring a license) or a frequency band used by the RFID for communication. In this case, interference with communication between the gNB 200 and the UE 100 does not occur, but interference between the passive links may occur. Therefore, as in the first embodiment, the gNB 200 controlling communication allows interference to be suppressed. The gNB 200 may configure, for the UE 100, any one or more of a frequency band (band or frequency bandwidth) to be used in the passive link, a frequency channel in the frequency band, and time information of the enabled or disabled frequency band or frequency channel (e.g., a radio frame number, a subframe number, a slot number, a bitmap indicating a permission/prohibition pattern for each radio frame or the like, time information, and the like). The UE 100 performs the passive link communication with the wireless tag 300 according to the configuration.

### Second Embodiment

A second embodiment is described.

In the second embodiment, the UE 100 requests the gNB 200 to allocate the passive link radio resource. To be more specific, first, the user equipment (e.g., the UE 100) requests the base station (e.g., the gNB 200) to allocate the first radio resource used for communication between the user equipment and the wireless tag (e.g., the wireless tag 300). Second, the base station transmits the first radio resource to the user equipment in response to the requesting.

Accordingly, for example, the gNB 200 can allocate the passive link radio resource in response to being requested by the UE 100. Therefore, as in the first embodiment, the gNB 200 can take the initiative to control the communication in the passive link through transmitting the passive link radio resource.

### Operation Example According to Second Embodiment

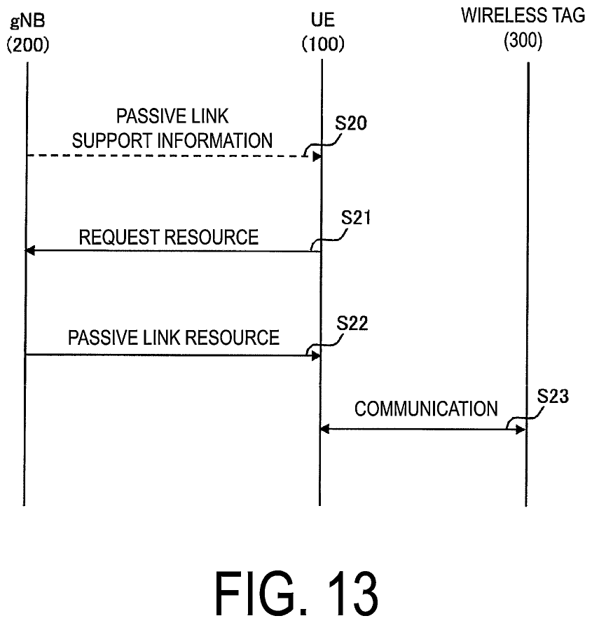

FIG. 13 is a diagram illustrating an operation example according to the second embodiment.

As illustrated in FIG. 13, in step S20, the gNB 200 may transmit information indicating that the passive link is supported to the UE 100. Hereinafter, the information indicating that the passive link is supported may be referred to as “passive link support information”. The passive link support information may also be information indicating that the gNB 200 does not support the passive link. The passive link support information may be information indicating whether the gNB 200 supports the passive link. The passive link support information may be included in the system information block (SIB) to be transmitted (broadcast).

First, the passive link support information may be included in an RRC message (dedicated signaling) such as an RRC reconfiguration (RRCReconfiguration) message to be transmitted. In this case, the passive link support information may imply that the passive link is permitted. The expression “the passive link is permitted” may represent that communication using the passive link is permitted to the UE 100. The expression “the passive link is permitted” may represent that a request for a radio resource to be used in the passive link is permitted. In addition, the expression “the passive link is permitted” may indicate that these two matters are permitted.

Second, the passive link support information may be information indicating the passive link is supported. The passive link support information may be information indicating that the passive link is permitted. The passive link support information may be information indicating a protocol of the supported or permitted passive link. The information indicating the protocol may include, for example, information indicating an RFID, information indicating Near Field Communication (NFC), or a standard name indicating the protocol.

In step S21, the UE 100 requests the gNB 200 to allocate a passive link radio resource. A transmission condition of the requesting may be the gNB 200 supporting the passive link, or the gNB 200 permitting the UE 100 the passive link (or the radio resource request used in the passive link). The UE 100 transmits the request in either case above. Content of the request may be at least one of the group consisting of the following.

First, the request may include information indicating that communication using the passive link is to be performed. The information may be information indicating an interest in communication using the passive link being performed.

Second, the request may include information regarding the radio resource desired to be used in the passive link. The information may be the same as the information regarding the radio resource described in the first embodiment. The information may be decided by the UE 100 taking into account the transmission time and/or reception time for the passive link.

Third, the request may include information indicating a protocol desired to be used in the passive link. The information may be the same as the information indicating the protocol included in the passive link support information.

Fourth, the request may include an amount of data to be transmitted and received in the passive link. The request may be the number of wireless tags 300 performing communication in the passive link.

Fifth, the request may include location information of the UE 100 itself. As described above, in the gNB 200, the passive link radio resource may be shared or dedicated based on the distance between the UE 100 and another UE. At this time, the gNB 200 may determine based on the location information of each UE.

Sixth, the request may include a transmit power of the passive link. In the gNB 200, the passive link radio resource may be shared or dedicated based on the transmit power for the UE 100 and another UE, which may be used as the reference information.

In step S22, in response to the request, the gNB 200 transmits the information regarding the passive link radio resource to the UE 100 (or the entire cell). A transmission method and contents of the information regarding the radio resource may be the same as those in the first embodiment. Thereafter, as in the first embodiment, the UE 100 communicates with the wireless tag 300 by using the passive link radio resource (step S23).

### Third Embodiment

A third embodiment is described.

The third embodiment is an embodiment for performing cell reselection with priority given to a cell supporting the passive link in the cell reselection by the UE 100.

The cell reselection is a procedure performed for the UE 100 in the RRC idle state or the RRC inactive state to migrate from a current serving cell to a neighboring cell due to moving. To be more specific, the UE 100 determines a neighboring cell to be camped on by the UE 100 through the cell reselection procedure and reselects the determined neighboring cell. The cell reselection is performed as follows, for example.

First, the UE 100 performs frequency-prioritization processing based on frequency-specific priorities specified by the gNB 200, for example, through a system information block or an RRC release message.

Second, the UE 100 performs measurement processing for measuring a radio quality of each of the serving cell and the neighboring cell. To be more specific, the UE 100 measures a received power and received quality of a reference signal (e.g., a Cell Defining-Synchronization Signal and PBCH block (CD-SSB)) transmitted by each of the serving cell and the neighboring cell.

Third, based on the measurement result, the UE 100 performs cell reselection processing for reselecting a cell to be camped on by the UE 100. To be more specific, the UE 100 may perform the cell reselection to the neighboring cell when the priority of the frequency of the neighboring cell is higher than the priority of the current serving cell and when the neighboring cell satisfies a predetermined quality criterion (i.e., a minimum quality criterion) for a predetermined period of time. When the priority of the frequency of the neighboring cell is the same as the priority of the current serving cell, the UE 100 may rank the radio qualities and perform the cell reselection to a neighboring cell having a rank higher than the rank of the current serving cell for a predetermined period of time. Furthermore, when the priority of the frequency of the neighboring cell is lower than the priority of the current serving cell and when the radio quality of the current serving cell is lower than a certain threshold as well as the radio quality of the neighboring cell is higher than another threshold continuously for a predetermined period of time, the UE 100 may perform the cell reselection to the neighboring cell.

In the third embodiment, the UE 100 may set the priority of a cell supporting a passive link to the highest priority to perform the cell reselection with priority given to the cell. Alternatively, the UE 100 may set the priority of the cell supporting the passive link to be higher than the priority of the serving cell.

To be specific, first, the base station (e.g., the gNB 200) transmits the passive link support information indicating whether the base station supports a passive link to the user equipment (e.g., the UE 100). Second, the user equipment performs the cell reselection with priority given to a cell supporting the passive link when the base station supports the passive link and a predetermined condition is met. Here, the predetermined condition includes any one of the user equipment having a wireless tag (e.g., the wireless tag 300) subordinate to the user equipment, the user equipment being interested in communication with the wireless tag using the passive link, and the user equipment being performing the communication with the wireless tag using the passive link.

Accordingly, for example, the UE 100 can camp on the cell supporting the passive link and appropriately communicate with the wireless tag 300. Operation Example according to Third Embodiment

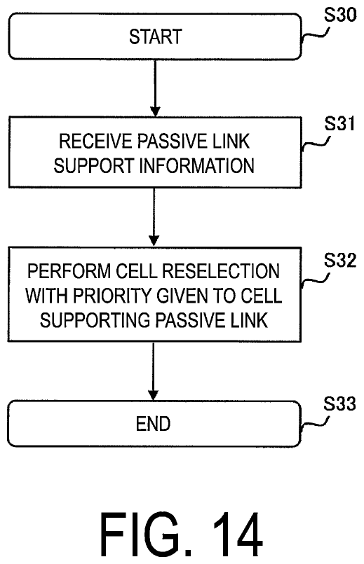

FIG. 14 is a diagram illustrating an operation example according to the third embodiment. Note that the UE 100 is in the RRC idle state or the RRC inactive state.

As illustrated in FIG. 14, in step S30, the UE 100 starts processing.

In step S31, the UE 100 receives the passive link support information from the gNB 200. The passive link support information may be information indicating whether the gNB 200 supports the passive link. The passive link support information may have the same content as the passive link support information described in the second embodiment. The passive link support information may be a configuration of a frequency priority to be applied by the UE 100 that performs the passive link. In the configuration, frequencies and priorities are associated with each other, in which a value different from the frequency priority applied by a normal UE 100 (not performing passive link) is set.

In step S32, the UE 100, after confirming that the gNB 200 supports the passive link based on the passive link support information, reselects, in priority to, a cell supporting the passive link when the predetermined condition is met. The predetermined condition includes any one of the UE 100 having the wireless tag 300, the UE 100 being interested in communication with the wireless tag 300 using the passive link, and the UE 100 being performing the communication with the wireless tag 300 using the passive link. When such a condition is met, the UE 100 performs the cell reselection by setting the priority of the cell supporting the passive link to the highest priority or setting the priority of the cell to a priority higher than the priority of the serving cell. The passive link support information may be a configuration of a frequency priority to be applied by the UE 100 that performs the passive link. In the configuration, frequencies and priorities are associated with each other, in which a value different from the frequency priority applied by a normal UE 100 (not performing passive link) is set. Then, the UE 100 camps on the cell.

Note that the predetermined condition may be either the UE 100 intending to perform communication with the wireless tag 300 using the passive link or the UE 100 being permitted to perform communication with the wireless tag 300 using the passive link.

In step S33, the UE 100 ends the series of processing.

### Other Embodiments

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (a chipset or a System on a Chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated”, but instead mean “may include only items stated” or “may include not only the items stated but also other items”.

The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

### SUPPLEMENTARY NOTE

Features relating to the embodiments described above are described below as supplements.
(1)

A communication control method in a wireless communication system, the communication control method including:
a step of transmitting, by a base station, a first radio resource used for communication between a user equipment and a wireless tag to the user equipment; and
a step of performing, by the user equipment, the communication with the wireless tag by using the first radio resource,
wherein the first radio resource is a radio resource different from a second radio resource used for the communication between the base station and the user equipment.
(2)

The communication control method according to (1) above, wherein
the step of transmitting includes a step of transmitting, by the base station, information specifying whether carrier sensing is required for the communication between the user equipment and the wireless tag.
(3)

The communication control method according to (1) or (2) above, wherein
the step of transmitting transmits, by the base station, the first radio resource that is a radio resource identical to a third radio resource to the user equipment when a distance between the user equipment and a different user equipment is equal to or more than a threshold, the third radio resource being used by the different user equipment for communication with a different wireless tag, and transmits, by the base station, the first radio resource that is a radio resource different from the third radio resource to the user equipment when the distance between the user equipment and the different user equipment is less than the threshold.
(4)

The communication control method according to any one of (1) to (3) above, further including:
a step of requesting, by the user equipment, an allocation of the first radio resource from the base station,
wherein the step of transmitting includes a step of transmitting, by the base station, the first radio resource to the user equipment in response to the step of requesting.
(5)

A communication control method in a wireless communication system, the communication control method including:
a step of transmitting, by a base station, passive link support information to a user equipment, the passive link support information indicating whether the base station supports a passive link; and
a step of performing, by the user equipment, cell reselection with priority given to a cell supporting the passive link when the base station supports the passive link and a predetermined condition is met,
wherein the predetermined condition includes any one of the user equipment having a wireless tag subordinate to the user equipment, the user equipment being interested in communication with the wireless tag by using the passive link, and the user equipment being performing the communication with the wireless tag by using the passive link.

### REFERENCE SIGNS

1: Wireless communication system
10: NG-RAN
20: 5GC (CN)
30: AMF
100: UE
110: Receiver
120: Transmitter
130: Controller
140: Reader/writer
141: RFID antenna
200: gNB
210: Transmitter
220: Receiver
230: Controller
250: Reader/writer
251: RFID antenna
300: Wireless tag
310: RFID antenna
320: Controller
330: Memory
340: Power supply

1. A communication control method in a wireless communication system, the communication control method comprising:
transmitting, by a network node, a first radio resource used for communication between a user equipment and a wireless tag to the user equipment; and
performing, by the user equipment, the communication with the wireless tag by using the first radio resource,
wherein the first radio resource is a radio resource different from a second radio resource used for the communication between the network node and the user equipment.

2. The communication control method according to claim 1, wherein
the transmitting comprises transmitting, by the network node, information specifying whether carrier sensing is required for the communication between the user equipment and the wireless tag.

3. The communication control method according to claim 1, wherein
the transmitting transmits, by the network node, the first radio resource that is a radio resource identical to a third radio resource to the user equipment when a distance between the user equipment and a different user equipment is equal to or more than a threshold, the third radio resource being used by the different user equipment for communication with a different wireless tag, and transmits, by the network node, the first radio resource that is a radio resource different from the third radio resource to the user equipment when the distance between the user equipment and the different user equipment is less than the threshold.

4. The communication control method according to claim 1, further comprising:
requesting, by the user equipment, an allocation of the first radio resource from the network node,
wherein the transmitting comprises transmitting, by the network node, the first radio resource to the user equipment in response to the requesting.

5. A user equipment in a wireless communication system, the user equipment comprising receiver circuitry and processing circuitry operatively associated with the transceiver circuitry and configured to execute processing of:
receiving, from a network node, a first radio resource used for communication between a user equipment and a wireless tag; and
performing the communication with the wireless tag by using the first radio resource,
wherein the first radio resource is a radio resource different from a second radio resource used for the communication between the network node and the user equipment.

6. A communication control method in a wireless communication system, the communication control method comprising:
transmitting, by a network node, passive link support information to a user equipment, the passive link support information indicating whether the network node supports a passive link; and
performing, by the user equipment, cell reselection with priority given to a cell supporting the passive link when the network node supports the passive link and a predetermined condition is met,
wherein the predetermined condition comprises any one of the user equipment comprising a wireless tag subordinate to the user equipment, the user equipment being interested in communication with the wireless tag by using the passive link, and the user equipment being performing the communication with the wireless tag by using the passive link.
